(19) United States
(12) Patent Application Publication
(10) Pub. No.: US 2024/0169117 A1
(43) Pub. Date: May 23, 2024

(54) FOAM IN PLACE SIMULATION METHOD

(71) Applicant: TACHI-S CO., LTD., Tokyo (JP)

(72) Inventor: Tsuyoshi TABATA, Ome (JP)

(21) Appl. No.: 18/384,337

(22) Filed: Oct. 26, 2023

(30) Foreign Application Priority Data
Nov. 17, 2022 (JP) 2022-184481

(51) Int. Cl. G06F 30/20; B29C 44/12; B29C 44/18; B29C 44/60

(52) U.S. Cl. CPC G06F 30/20; B29C 44/1271; B29C 44/181; B29C 44/60; B29K 2105/04

(57) ABSTRACT

Provided is a foam in place simulation method that simulates steps of forming a foam in place molded product by supplying a foaming raw material inside a surface skin that is disposed inside a mold through an inlet port thus filling a foamed body into the surface skin. The method is configured to simulate the steps of: setting a shape of the inside of the mold as a fixed boundary condition; setting a material characteristic value of the surface skin whose shape changes corresponding to a filling state of the foamed body into the surface skin; and forming the foam in place molded product from the surface skin by filling the foamed body into the surface skin based on the shape of the surface skin at the time of setting the surface skin inside the mold based on the fixed boundary condition and the material characteristic value.

### CLAIM OF PRIORITY

The present application claims priority from Japanese patent application JP2022-184481 filed on Nov. 17, 2022, the content of which is hereby incorporated by reference into this application.

### BACKGROUND

The present invention relates to a foam in place simulation method.

In an injection molding method, as a method of performing an analysis of the flow of a material inside a mold, for example, there has been known a method described in JP-A-2008-188957. The method is a flow analysis method for injection molding where a flow process of a fluid is analyzed by a numeral analysis using shell meshes obtained by dividing the shape of an injection molded product into a plurality of minute components. In the flow analysis of the fluid, arithmetic processing is applied to a viscosity formula that includes a function expressed by a wall thickness difference and a speed of the fluid for every minute component thus analyzing the flow of the fluid.

### SUMMARY

With respect to a headrest, an arm rest or the like for a vehicle, in a state where a surface skin formed of a cloth or a leather (an artificial leather) in which a structure formed of a metal-made pipe or the like is mounted inside a mold, a foaming raw material is injected into the surface skin, and the foaming raw material is foamed so that the inside of the surface skin is filled with a foamed body. Accordingly, the foamed body is integrally formed with the structure mounted inside the surface skin.

In this case, a cloth or a leather that forms a surface skin is formed using a flexible material and hence, in a state where the surface skin is mounted inside the mold, the surface skin is held in a deformed shape without being brought into contact with the mold.

When a foaming raw material is injected into the surface skin and is foamed, and the foamed body is filled into the surface skin in such a state, the flexible surface skin is expanded while being pushed by the foamed material (foamed body) and is deformed until the surface skin is brought into contact with the mold.

In a case where a flow analysis is applied to the step where the foamed body is formed by injecting the foaming raw material into the surface skin that is formed of a flexible member, in the analysis method which uses a fixed boundary described in patent literature 1 as a premise, a case arises where the deformation of a cloth or a leather in an actual injection step of a resin material is not reflected to the flow analysis and hence, accuracy of the flow analysis is lowered. In a case where the foamed body is formed by injecting the foaming raw material into the surface skin using the mold manufactured based on such a flow analysis, a void is formed between the surface skin and the foamed body and hence, the mold becomes defective whereby there arises a drawback that the mold has to be reformed.

The present invention has been made to overcome the drawback of the above-mentioned conventional art, and it is an object of the present invention to provide a foam in place simulation method that is also applicable to a case where a foamed body is formed by injecting a foaming raw material into a surface skin formed of a flexible member in a state where the surface skin is mounted inside a mold. To overcome the above-mentioned drawback, the present invention provides a foam in place simulation method that simulates steps of forming a foam in place molded product by supplying a foaming raw material inside a surface skin formed of a flexible member that is disposed inside a mold through a inlet port thus filling a foamed body into the surface skin, wherein the method is configured to simulate the steps of: setting a shape of the inside of the mold as a fixed boundary condition; setting a material characteristic value of the surface skin whose shape changes corresponding to a filling state of the foamed body inside the surface skin; and forming the foam in place molded product from the surface skin based on the material characteristic value and the fixed boundary condition by filling the foamed body into the surface skin based on the shape of the surface skin at the time of setting the surface skin inside the mold based on the fixed boundary condition and the material characteristic value.

According to the present invention, accuracy of a flow analysis can be increased by reflecting the deformation of a surface skin corresponding to a material characteristic value of a cloth or a leather in an actual injection step of a resin material and hence, the number of reforming a mold can be reduced.

### BRIEF DESCRIPTION OF DRAWINGS

FIG. 1 is a perspective view illustrating an external appearance of a headrest for a vehicle.

FIG. 2 is a cross-sectional view taken along a line A-A in FIG. 1.

FIG. 3 is a perspective view of a mold used for forming a foamed body by filling an amount of foaming raw material into a surface skin of the headrest.

FIG. 4 is a cross-sectional view of the mold in a state where the headrest is set in the mold.

FIG. 5 is a cross-sectional view of the mold illustrating a state where a void is formed between the surface skin of the headrest and the mold in a state where an amount of foaming raw material is filled into the headrest.

FIG. 6 is a cross-sectional view of the mold in a state where a headrest whose posture is changed is set in the surface skin.

FIG. 7 is a cross-sectional view of the mold illustrating a state where a void is not formed between the sur face skin of the headrest and the mold in a state where an amount of foaming raw material is filled into the headrest.

FIG. 8 is a flowchart illustrating steps of a flow analysis based on an embodiment of the present invention.

FIG. 9 is a flowchart illustrating steps of manufacturing the headrest using a flow analysis method based on the embodiment of the present invention.

### DESCRIPTION OF THE PREFERRED EMBODIMENTS

In the present invention, in the method for simulating the steps of forming a foamed body by injecting a foaming raw material into the surface skin member in a state where a surface skin member in which a structure is mounted is mounted in the mold, a boundary condition is set using the surface skin member in which the structure is mounted as a flexible material. Accordingly, by enabling the reflection of the deformation of the surface skin member in the actual injection step of the foaming raw material, the accuracy of flow analysis in the foam in place simulation can be increased and hence, an analysis closer to an actual injection step can be realized. As a result, the mold structure where a void is not generated between a surface skin member and the inside of the foamed body can be obtained by the foam in place simulation whereby the number of reforming the mold can be reduced.

An embodiment of the present invention is described hereinafter with reference to drawings. However, it should not be construed that the present invention is limited to the content described in the present invention. Those who are skilled in the art can easily understand that the specific configuration can be modified without departing from the concept or the gist of the present invention.

### Embodiment

As an embodiment of the present invention, a case where the present invention is applied to a headrest for a vehicle is described with reference to drawings.

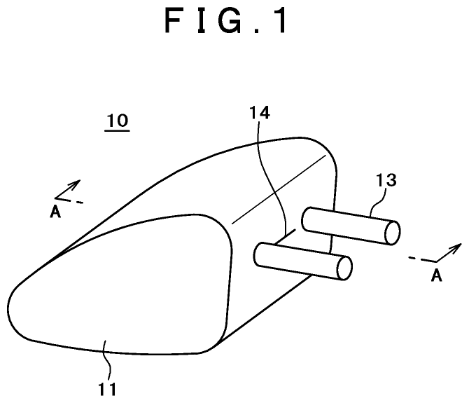

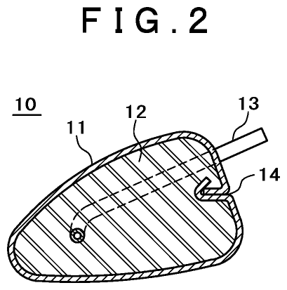

FIG. 1 is a perspective view illustrating an external appearance of a headrest 10 for a vehicle, and FIG. 2 is a cross-sectional view taken along a line A-A in FIG. 1. The headrest 10 includes: a surface skin (a trim cover) 11 that is formed by seaming a relatively flexible material such as a cloth or a leather (an artificial leather) such that the surface skin 11 covers an outer portion of the headrest 10; a foamed body (for example, urethane) 12 that is filled into the surface skin 11; and a stay 13 formed of a metal-made pipe for mounting and fixing the headrest 10 to a seatback of a seat of a vehicle not illustrated in the drawing. Numeral 14 indicates an inlet port for filling a foaming raw material that becomes a material of the foamed body 12 inside the surface skin 11.

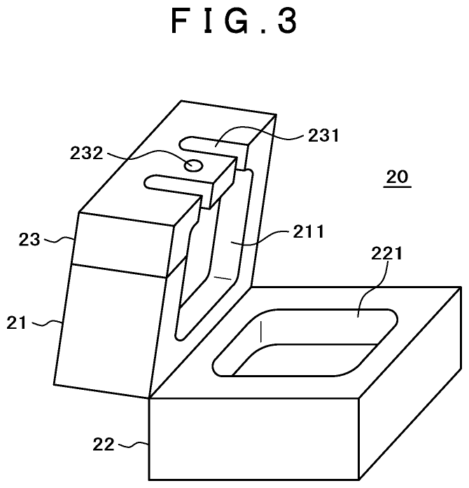

FIG. 3 illustrates a mold 20 that is used for forming the foamed body 12 by filling an amount of foaming raw material into the surface skin 11. The mold 20 includes an upper mold 21, a lower mold 22 and a front mold 23 that are formed using a metal or a resin. In the upper mold 21, an upper mold shape 211 that corresponds to an upper side shape of the headrest 10 in a state where the headrest 10 is laid down horizontally (a state illustrated in FIG. 1) is formed. In the lower mold 22, a lower mold shape 221 that corresponds to a lower side shape of the headrest 10 in a state where the headrest 10 is laid down horizontally is formed. The front mold 23 corresponds to a lower portion of the headrest 10, and a pair of grooves 231 through which the stays 13 pass and a pipe hole 232 for filling a foaming raw material inside the surface skin 11 are formed in the front mold 23.

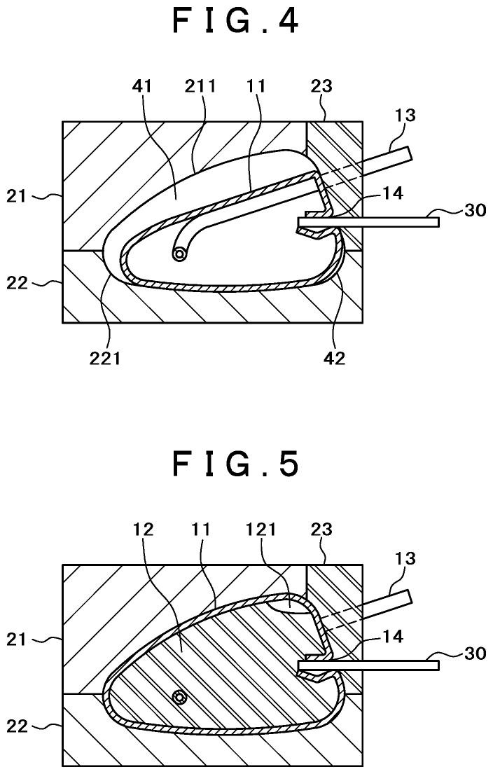

As illustrated in FIG. 4, the headrest 10 is set between the upper mold 21 and the lower mold 22 in a state where the stay 13 is mounted on the surface skin 11. In such a state where a nozzle 30 is inserted into the surface skin 11 from the inlet port 14 through the pipe hole 232, the surface skin 11 that is formed using a relatively flexible material sags due to gravity, and gaps 41, 42 are generated between the surface skin 11 and the upper mold shape 211, the lower mold shape 221 respectively.

In a state where the surface skin 11 is set between the upper mold shape 211 formed in the upper mold 21 and the lower mold shape 221 formed in the lower mold 22, the foaming raw material 120 that is supplied from a supply means not illustrated in the drawing is supplied to the inside of the surface skin 11 from the nozzle 30 inserted into the inlet port 14. The foaming raw material that is supplied to the inside of the surface skin 11 is foamed thus forming the foamed body 12. The flexible surface skin 11 that is in a sagged state due to gravity is pushed and inflated by the foamed body 12, and the air that has existed between the upper mold shape 211, the lower mold shape 221 and the surface skin 11 is released to the outside of the mold 20. The foamed body 12 expands inside the surface skin 11 while being foamed so that the surface skin 11 is deformed until the surface skin 11 is brought into close contact with the upper mold shape 211 and the lower mold shape 221 of the mold 20. At this stage of the operation, air remaining inside the surface skin 11 is pushed by the foamed body 12, and is released to the outside through a gap formed between the inlet port 14 formed in the surface skin 11 and the nozzle 30 and a gap formed between the nozzle 30 and the pipe hole 232. A temperature of the foamed body 12 that expands inside the surface skin 11 is gradually lowered, and the foamed body 12 is solidified in a state where the foamed body 12 holds the shape that inflates inside the surface skin 11.

However, in a case where the inclination of the upper mold shape 211 and the inclination of the lower mold shape 221 formed in the mold 20 (corresponding to a posture (inclination) of the headrest 10 disposed inside the mold 20) are not appropriate, when the foamed body 12 that is formed by foaming inside the surface skin 11 expands along the upper mold shape 211 and the lower mold shape 221, the air inside the surface skin 11 cannot be completely released through the gap between the inlet port 14 formed in the surface skin 11 and the nozzle 30 and hence, the air remains inside the surface skin 11, or the foamed body 12 shrinks due to lowering of a temperature of the foamed body 12 and hence, there arises a case where a void 121 illustrated in FIG. 5 is generated between the surface skin 11 and the foamed body 12. In such a case, the headrest 10 becomes a defective product.

In this case, it is necessary to reform the mold 20 to avoid the formation of the void 121. Accordingly, there arises a drawback that steps and a cost for remanufacturing of the mold 20 are increased and hence, it takes time until a satisfying headrest 10 is manufactured.

In this case, when the foaming raw material 120 is supplied to the inside of the surface skin 11 in a state where the rigid stay 13 that is formed of a metal-made pipe is mounted inside the surface skin 11 and the foamed body 12 is foamed inside the surface skin 11, the surface skin 11 formed using a flexible material is inflated by being pushed by the foamed body 12. As a result, a gap between the stay 13 and the surface skin 11 changes so that a flow resistance of the foamed body 12 changes whereby the flow of the foamed body 12 inside the surface skin 11 changes.

In performing the flow analysis with respect to the step of forming the foamed body 12 by injecting the foaming raw material 120 into the surface skin 11 that is formed using a flexible material, in the analysis method described in patent literature 1 where the solid boundary is adopted as a premise, a change in a cross-sectional shape of a flow path of the foamed body 12 generated between the foamed body 12 and the stay 13 due to the deformation (elongation) of the surface skin 11 formed using a relatively flexible material in the injection step of the actual foaming raw material 120 is not reflected whereby the accuracy of the flow analysis is lowered.

That is, in the actual step of injecting a foaming raw material, the surface skin 11 is pushed out in a direction that the surface skin 11 is inflated due to the injection of the foaming raw material. As a result, a distance between the stay 13 and the surface skin 11 in the vicinity of the stay 13 is enlarged and hence, the resistance of the inflow (fluidity resistance) of the foamed body 12 is reduced whereby a speed of diffusion (flow) of the foamed body 12 inside the surface skin 11 changes. However, with respect to the analysis method which was proposed on the premise of a fixed boundary, this change of flow cannot be reflected. As a result, as has been described with reference to FIG. 5, air inside the surface skin 11 cannot be completely released to the outside through a gap between the inlet port 14 formed in the surface skin 11 and the nozzle 30 and remains in the gap and hence, the generation of the void 121 between the surface skin 11 and the foamed body 12 cannot be prevented thus giving rise to a possibility that a defective product is produced.

To the contrary, in the present embodiment, the surface skin 11 is treated as a flexible member. That is, in the present embodiment, a flexible boundary condition is set such that, corresponding to a state that a foaming raw material is injected into the surface skin 11 so that the foamed body 12 is formed, the surface skin 11 is pushed out and extended toward the outside so that boundary is changed. That is, the distance between the stay 13 and the surface skin 11 in the vicinity of the stay 13 is changed corresponding to the formation state of the foamed body 12 and hence, the simulation of a flow analysis closer to an actual step of injecting a foaming raw material can be performed.

Accordingly, it is possible to perform the simulation that reflects a change in a speed of diffusion (flow) of the foamed body 12 inside the surface skin 11 in the actual step of injecting a foaming raw material. As a result, it is possible to obtain the posture of the surface skin 11 where, as the foamed body 12 is filled into the surface skin 11, the air remaining inside the surface skin 11 can be released to the outside with certainty through the gap between the inlet port 14 formed in the surface skin 11 and the nozzle 30. Accordingly, it is possible to obtain, by simulation, the shape of the mold 20, that is, the upper mold shape 211 and the lower mold shape 221 corresponding to the posture of the surface skin 11.

That is, it is possible to perform the simulation that reflects a change in speed of diffusion (flow) of the foamed body 12 inside the surface skin 11 in the actual step of injecting a foaming raw material. Accordingly, as the shape of the mold 20 formed of the upper mold shape 211 and the lower mold shape 221, it is possible to obtain, by simulation, the shape suitable for preventing the formation of the void 121 between the foamed body 12 and the surface skin 11 where, as the foamed body 12 is filled into the surface skin 11, by allowing air inside the surface skin 11 to be released with certainty from the gap between the inlet port 14 formed in the surface skin 11 and the nozzle to the outside.

To treat the surface skin 11 as a flexible member in the simulation of a flow analysis, it is necessary to measure material characteristics of the surface skin 11 in advance. As the material characteristics of the surface skin 11 to be measured, density (weight per unit area), elongation ratios (elongations in the longitudinal direction and the lateral direction with respect to a unit tensile strength) and the like of the surface skin 11 are measured.

In performing the flow analysis, in addition to the material characteristic values obtained by performing these measurements, a limit of elongation (for example, 5% in a case where the surface skin 11 is formed using a leather, and 20% in a case where the surface skin 11 is formed using a cloth, for example) is set. With such setting, the shapes of the upper mold shape 211 and the lower mold shape 221 (corresponding to the posture (inclination) of the headrest 10) in the mold 20 where the void 121 in which air remains is not formed between the foamed body 12 and the surface skin 11 are decided.

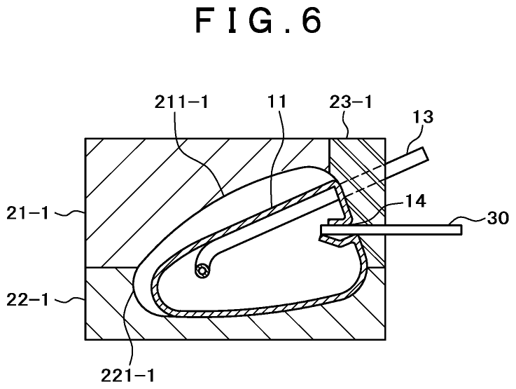

FIG. 6 illustrates an upper mold 21-1 in which the upper mold shape 211-1 is formed, a lower mold 22-1 in which a lower mold shape 221-1 is formed, and a front mold 23-1, all of which are obtained by such simulation.

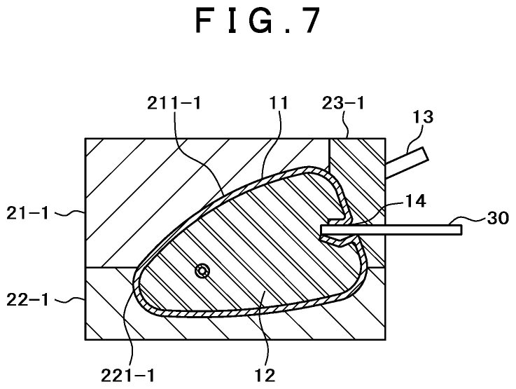

By injecting a foaming raw material from the nozzle 30 that is inserted into the surface skin 11 from the inlet port 14 using such a mold 20, as illustrated in FIG. 7, the foamed body 12 is filled into the surface skin 11 so that the surface skin 11 traces the shape of the upper mold shape 211-1 and the shape of the lower mold shape 221-1. Accordingly, it is possible to prevent the generation of the void 121 between the surface skin 11 and the foamed body 12 in such a state.

As a result, in this embodiment, it is possible to prevent reforming the mold 20, or the number of reforming the mold 20 can be reduced.

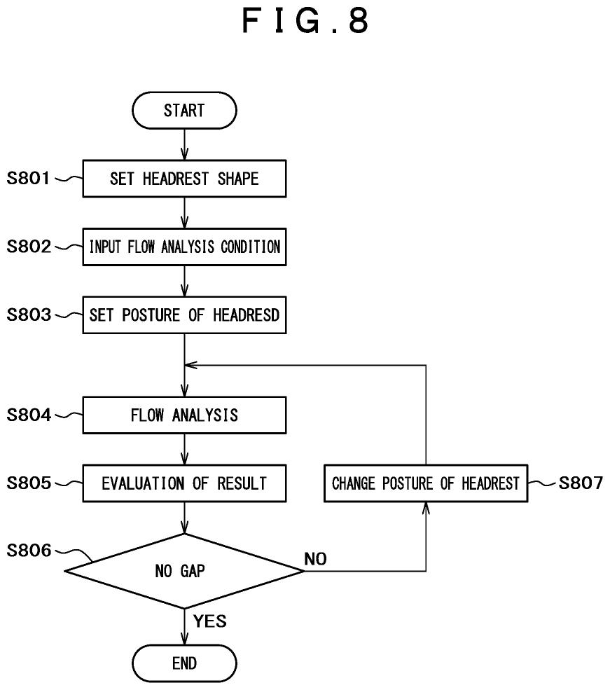

FIG. 8 illustrates steps of an foam in place simulation method based on the present embodiment.

First, by setting a final shape of the headrest 10 including the stay 13 using mesh cells that are formed of a plurality of minute divided elements, the shape of the inside of the mold that corresponds to the final shape of the headrest 10 is set as a fixed boundary condition (S801).

Next, to set material characteristic values of the surface skin whose shape is changed corresponding to a filling state of the foamed body in the surface skin, limit conditions of material characteristics and the elongation of the surface skin 11 that are measured in advance, and various conditions for the flow analysis (resin data including viscosity, density, specific heat, thermal conductivity, a flow stopping temperature and the like of a foaming raw material, injection data such as a temperature, an injection pressure, an injection flow speed and the like of the foaming raw material, and mold data such as thermal conductivity, a specific heat and the like of the mold) are inputted (S802).

Next, the shape of the surface skin when the surface skin is set inside the mold is calculated based on the fixed boundary condition and the material characteristic values, and a posture of the headrest 10 with respect to the mold 20 (corresponding to the inclination of the headrest 10 with respect to a reference surface set in the mold 20) is set (S803).

Next, the flow analysis is performed where a change in the shape of the surface skin 11 brought about by filling of the foamed body 12 into the surface skin 11 from the shape of the surface skin 11 when the surface skin 11 is set inside the mold 20 is simulated based on the material characteristic values and the fixed boundary condition thus obtaining the shape of an integral foamed molded product in a state where the foamed body 12 is filled into the surface skin 11 (S804).

Next, the state in which the inside of the surface skin 11 is filled with the foamed body 12 that is obtained in S804 is evaluated, and it is checked whether or not the void 121 in which air remains is formed between the surface skin 11 and the foamed body 12 (S805).

In the case where the void 121 in which air remains is formed between the surface skin 11 and the foamed body 12 (No in S805), the posture of the headrest 10 in the mold 20 is changed (S806), a flow analysis is performed again by returning to S804, and a state where the inside of the surface skin 11 is filled with the foamed body 12 is obtained.

On the other hand, in the case where it is checked that the void 121 in which air remains is not formed between the surface skin 11 and the foamed body 12 (Yes in S805), the flow analysis is finished, and the mold 20 is designed based on the result of this analysis.

As data of the material characteristic of the surface skin 11 inputted in S802, the elongation ratio may be set to be changed corresponding to the shape of the surface skin. That is, the elongation ratio of the surface skin 11 of a portion where a plurality of surface skin members are seamed together, a portion having a folded shape or a portion near such a portion may be set to a value different from the elongation ratio (for example, smaller) of the surface skin 11 at a flat portion. By setting the elongation ratio of the surface skin 11 to be partially changed corresponding to the shape of the surface skin, the simulation closer to an actual step of filling the foamed body 12 can be performed.

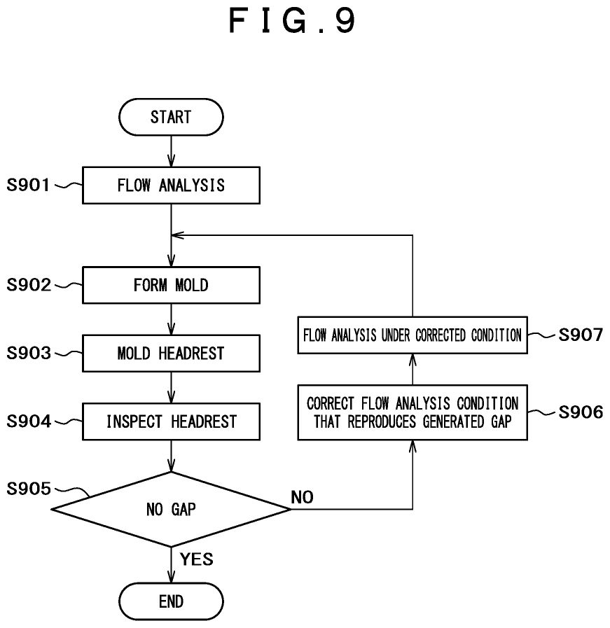

Next, a method of manufacturing the headrest 10 using such a flow analysis method is described with reference to FIG. 9.

First, by performing a flow analysis of the foamed body 12 inside the surface skin 11 described with reference to FIG. 8, the shape of the mold 20 for forming the headrest 10 (the shapes of the upper mold shape 211-1 and the lower mold shape 221-1 illustrated in FIG. 6, and shapes of portions around the upper mold shape 211-1 and the lower mold shape 221-1) is decided (S901).

Next, the mold 20 having the shape decided in S901 is formed (S902), and the foamed body 12 is filled into the surface skin 11 using the formed mold 20 thus forming a headrest 10 (S903).

Next, the formed headrest 10 is taken out from the mold 20, and it is checked whether or not the void 121 in which the foamed body 12 is not filled is generated inside the surface skin 11 (S904).

In the case where the void 121 in which the foamed body 12 is not filled (see FIG. 5) is not generated inside the surface skin 11 (Yes in S904), the mold 20 formed in S902 is determined to be a non-defective product and the evaluation of the mold 20 is finished. Then, the headrests are manufactured using this mold 20.

On the other hand, in the case where the void 121 in which the foamed body 12 is not filled is generated inside the surface skin 11 (No in S904), by repeatedly performing a flow analysis by exchanging a portion of the flow analysis condition inputted in S802 in the flow analysis described in FIG. 8, it is possible to obtain the flow analysis condition that enables the reproduction of the actually generated void 121 (S905).

Next, when the flow analysis condition where the actually generated void 121 is reproduced is obtained, the steps from S803 to S806 are performed using this flow analysis condition, and the shape of the mold 20 to be modified for preventing the generation of the void 121 is obtained (S906) and, then, the processing advances to S902 thus forming the mold 20 having the shape decided in S906.

In this manner, by deciding the shape of the mold 20 by performing the flow analysis described with reference to FIG. 8, it is possible to obtain the shape of the mold 20 in which the void 121 is not generated while setting the number of times that the mold 20 is reformed smaller compared to the prior art.

As has been described above, according to this embodiment, in the foam in place simulation method that simulates steps of forming the foam in place molded product by supplying the foaming raw material inside the surface skin formed of a flexible member that is disposed inside the mold through the inlet port thus filling the foamed body into the surface skin, the method is configured to simulate the steps of: setting the shape of the inside of the mold as the fixed boundary condition, setting the material characteristic value of the surface skin whose shape changes corresponding to the filling state of the foamed body in the surface skin, calculating the shape of the surface skin when the surface skin is set inside the mold based on the fixed boundary condition and the material characteristic value; and forming the foam in place molded product from the surface skin based on the material characteristic value and the fixed boundary condition by filling the foamed body into the surface skin based on the shape of the surface skin at the time of setting the sur face skin inside the mold.

According to this embodiment, in the simulation where the foamed body 12 is filled with the surface skin 11 by injecting the foaming raw material 120 into the inside of the headrest 10, the surface skin 11 is formed using a flexible material, and the boundary condition is set such that the shape of the surface skin 11 changes corresponding to a filling state of the formed body 12 and hence, an accuracy of the flow analysis of the foamed body 12 inside the surface skin 11 can be increased and hence, the number of reforming the mold can be reduced.

In the above-mentioned embodiment, the description has been made with respect to the case where the present invention is applied to forming of the headrest 10. However, the present invention is also applicable to the case where an armrest is formed or other members that are formed by filling a foamed body.

In the above-mentioned embodiment, the description has been made with respect to the case where the foamed body 12 is generated inside the surface skin 11 by supplying the foaming raw material 120 in a state where the rigid stay 13 formed using a metal-made pipe is mounted inside the surface skin 11. However, the rigid stay 13 may not be mounted inside the surface skin 11. Further, a structure that is formed using a flexible material may be disposed in place of the rigid stay 13.

The invention made by the present inventors has been specifically described heretofore. However, it is needless to say that the present invention is not limited to the above-mentioned embodiment, and the various modifications can be made without departing from the gist of the present invention. For example, the above-mentioned embodiment has been described in detail for facilitating the understanding of the present invention. However, an object of the present invention is not always limited to the configuration described above. Further, with respect to some configuration of the embodiment, the addition, the deletion, and the replacement of other configurations can be performed.

What is claimed is:

1. A foam in place simulation method that simulates steps of forming an foam in place molded product by supplying a foaming raw material inside a surface skin formed of a flexible member that is disposed inside a mold through an inlet port thus filling a foamed body into the inside of the surface skin, wherein the method is configured to simulate the steps of:
setting a shape of the inside of the mold as a fixed boundary condition;
setting a material characteristic value of the surface skin whose shape changes corresponding to a filling state of the foamed body into the inside of the surface skin; and
forming the foam in place molded product from the surface skin based on the material characteristic value and the fixed boundary condition by filling the foamed body into the inside of the surface skin based on the shape of the surface skin at the time of setting the surface skin in the inside of the mold based on the fixed boundary condition and the material characteristic value.

2. The foam in place simulation method according to claim 1, wherein
the simulation method calculates the shape of the surface skin at the time of setting the surface skin in the inside of the mold based on the fixed boundary condition and the material characteristic value.

3. The foam in place simulation method according to claim 1, wherein
a structure is mounted in the inside of the surface skin, and a distance between the surface skin and the structure changes corresponding to a state of filling of the foamed body into the inside of the surface skin based on the material characteristic value of the set surface skin.

4. The foam in place simulation method according to claim 1, wherein
as the material characteristic value of the surface skin, a weight of the surface skin per unit area, an elongation ratio of the surface skin, and a limit of elongation of the surface skin are inputted.
